(19) United States
(12) Patent Application Publication
(10) Pub. No.: US 2004/0006548 A1
(43) Pub. Date: Jan. 8, 2004

(54) Subscriber profile matching and positioning system for mobile units in a communication system

(76) Inventor: Valadi Mahmood, Taby (SE)

Correspondence Address: NIXON & VANDERHYE, PC, 1100 N GLEBE ROAD, 8TH FLOOR, ARLINGTON, VA, 22201-4714, US

(21) Appl. No.: 10/380,691

(22) PCT Filed: Sep. 20, 2001
(86) PCT No.: PCT/SE01/02020

(30) Foreign Application Priority Data
Sep. 20, 2000 (SE) 0003346-4

(51) Int. Cl. G06F 7/00

(52) U.S. Cl. 707/1

(57) ABSTRACT

A telephony network comprises telephone sets such as mobile telephones (1) connected to a server (3) that contains a database having information on persons looking to meet other persons. Using the telephones, a server information can be input to server both in regard of a person looking to meet another person and of a desired person. The server receives such personal information, stores it in the database and compares the personal information to find persons, the information of whom, for persons looking to meet another persons, agrees with the received information on the desired person, to determine a list that is transmitted to the telephone can be shown on the display (11) thereof. On the telephone a selection of a person in the transmitted list can be made and information on the selected person is transmitted to the server that can then establish a telephone connection between the telephone of the person looking to meet another person and the telephone of the selected person. Then, no telephone number presentation must be made to guarantee the anonymity. In the case where the telephones are mobile telephones, the server can have the feature of determining the geographical positions thereof, to give, when the geographical distance between the two mobile telephones is small, such as for an appointed meeting between persons looking for meet other persons, a signal thereof to the mobile telephones, such as activating a ring signal and establishing a telephone connection between them.

The invention relates to a telephony network having extended functions, in particularly in regard of processing contacts with other people such as personal advertisements.

### BACKGROUND OF THE INVENTION

Personal advertisements are printed in newspapers for facilitating for a person to come in contact with other persons for different kinds of meetings. The personal advertisements comprise a telephone number to the service means that provides the service of arranging contacts and generally a number code indicating the person who desires contact and for whom personal information is indicated in the message. Many people can find it embarrassing that such information about themselves is printed though the information is anonymous. Therefore, dating offices exist to which persons wanting contact send personal information both in regard of themselves and in regard of the person searched for or wanted. This information is then stored by the dating office in a database and it then searches the database for persons the information of whom can agree with the information indicated by the person desiring contact. The dating office then sends usually written messages to one of or both persons so that they can arrange a meeting.

A network for providing contacts is disclosed in U.S. Pat. No. 6,061,681. The network comprises computers and fixed telephone sets connected thereto. The fixed telephones are connected to local servers provided with voice response units. Through a telephone or computer connected to the Internet a user can enter information on desired contacts which are then compared to information stored in a database in a local server. In the case of agreement, a list of found persons can be read out in the telephone set of the user or it can be displayed on the monitor belonging to the computer of the user.

In U.S. Pat. No. 5,818,836 among other things a system is disclosed according to which a user can select a printed personal advertisement, make a telephone call to an associated system and enter a number indicated in the message. The system then makes a telephone call to person indicated in the message and can obtain the person's permission to establish an anonymous connection between the user and the-indicated person.

### SUMMARY OF THE INVENTION

It is an object of the invention to provide devices for facilitating contact between persons.

It is another object of the invention to provide devices for establishing contacts between persons who desire contact, which devices ensure the anonymity of the persons as long as they want it.

Thus a telephone network is provided comprising telephones, in particularly mobile telephones, that through the network are connected to a server having a special design. The telephones comprise means for entering personal information both in regard of a person looking for contact and in regard of a desired person and furthermore means for transferring the personal information to the server. The server comprises means for receiving such personal information and storing it in a database. Furthermore, the server has means for determining, by-comparing received information for a desired person to information previously stored in the database for persons desiring contact, the personal information of whom totally or partly agrees with the personal information of desired person. The server also comprises means for transmitting to the telephone a list of the found persons which by means arranged in the telephone can be displayed on the monitor or display unit of the telephone. On the telephone a selection of a person on the transmitted list can be made and information on selected person is then transmitted to the server. The server can advantageously comprise means for establishing, when receiving information of a selected person, a telephone connection between the telephone set of the person desiring contact and the telephone set of the selected person, and then if this has been requested, for example in conjunction with transmitting the personal information, no presentation or displaying of telephone numbers is made to either one of or both telephones.

In the case where the telephones are mobile telephones, the telephone network can comprise means for localizing, i.e. determining the geographical positions of, mobile telephones connected to the mobile telephone network. Then the server can comprise means for determining the geographical distance between two mobile telephones connected to the network and to transmit to the mobile telephones, when they are at a distance from each other lower than a threshold value, a signal thereof to the mobile telephones. This can for example be the case when a person desiring contact and a desired person have arranged a meeting with each other. Such a system can advantageously supplement/replace the common personal advertisements, in particularly in the case where the server is arranged to transmit, as a signal, ring signals to the mobile telephones, so that a connection can be established between the mobile telephones over the telephone network.

### BRIEF DESCRIPTION OF THE DRAWING

The invention will now be described by way of a non-limiting embodiment with reference to the accompanying drawing in which:

FIG. 1 is a schematic picture of mobile telephones communicating with a network.

### DETAILED DESCRIPTION

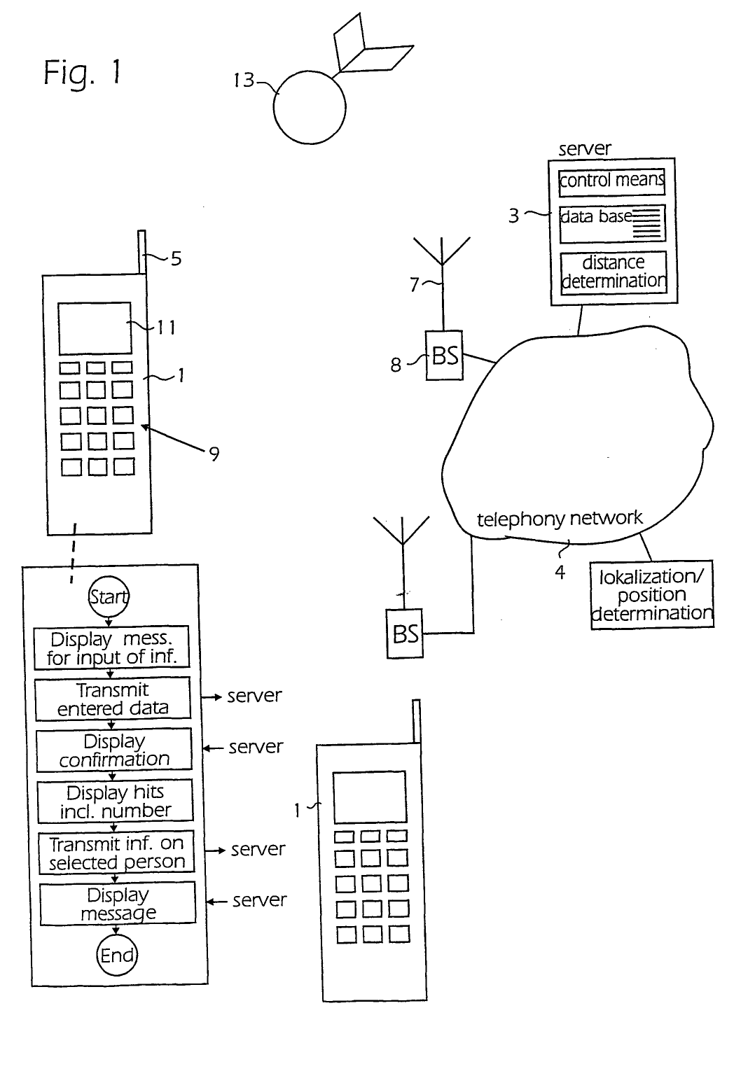

In FIG. 1 a mobile telephone 1 is illustrated having built-in intelligence for handling, transmitting and receiving data: and provided with a special function for handling personal searches for contact. This function can be initially installed in the mobile telephone or can be downloaded from a server 3 in a telecommunication network 4 with which the mobile telephone 1 can wirelessly communicate through an antenna 5 of the mobile telephone and an antenna 7 of a base station 8 in the network. In the mobile telephone the special function is called or started by a suitable choice of menu made by depressing suitable keys on the keyboard 9 of the mobile telephone. Then, on the display 11 of the mobile telephone a message is displayed that personal information can now be entered, first for the person who desires contact and who can be assumed to be the person that now uses the mobile telephone and then for the desired person, i.e. the person searched for. Personal information on the searching person can include name, address, sex, age, weight, interests, etc. and information whether the person is willing to take the whole cost for the service or is willing to take only half the cost. Furthermore, information can be entered whether the person is willing to tell her/his telephone number to other persons. For the desired person information of sex, age, weight, residential area, etc. can be entered.

After all the information has been entered, the person can depress suitable keys such as is told by information shown on the display 11, so that a message containing all the entered information is transmitted to the server 3. The server receives the message and transmits an acknowledging message to the mobile telephone 1 that is shown on the display 11 thereof. In the server 3 the now received information is stored in a database comprising data for all persons who search for contact with other persons in the server. Then, in the server a sorting operation can be made for the considered person, either on a particular command transmitted from the mobile telephone and/or automatically when receiving the personal information. The result of such a sorting operation can include a list having graded hits, where first hits within the residential area searched for are listed, then hits within geographical regions next to it, then hits at a larger distance of the area searched for, etc. The total number of hits within the respective geographical areas can also be counted. A hit can mean a person, for whom information is stored in the database and for whom this information more or less well agrees with the profile for desired person that has been entered from the mobile telephone. Then a message is transmitted to the mobile telephone containing the sorted list together with the number of found persons having addresses within different geographical areas. The numbers and the list are displayed on the display of the mobile telephone and the user can navigate in the list by depressing keys.

When the user find a profile of a person with whom she/he wants contact, it is indicated by depressing suitable key/keys on the keyboard 9. A message of selected person is then transmitted to the server 3 that establishes a telephone connection with the desired person, the connection being hidden if this been has been requested in a previous input operation. The telephone number for either party can thus be hidden by being in the conventional way indicated as a protected/secret telephone number. In the established telephone connection the connected persons can agree on time and place for a meeting. If a telephone connection with the selected person can not now be established, the server can by a suitable message to the user of the mobile telephone ask whether a later call will be made, the possible time thereof, etc. The server 3 then stores the received information and later tries to establish the telephone connection.

After the server 3 has received a message of selected person, it monitors the mobile telephones of the person wanting contact and the selected person, so that it can receive, as soon as these mobile telephones are active, information on the geographical position of the mobile telephones and in particularly on their geographical distance of each other. This can advantageously in a known way be accomplished by determination of position using the conventional radio signals used for communication with the network 4, that are transmitted from mobile telephones and that are received by several different base stations 8, or, if such a localizing function is not provided in the network, by GPS receivers, not shown, that are built into the mobile telephones 1 and are connected to and receive signals from a satellite 13. When the server 3 finds that the mobile telephone of the first mentioned person and mobile telephone of the selected person are at a sufficiently small geographical distance of each other what can both occur at random when the persons move around and when the persons approach the place for a meeting agreed upon according to the discussion above, and provided that they have their mobile telephones connected to the network, a ring signal is provided to the two mobile telephones, a suitable message such as “The person you are to meet is quite near” is displayed on the displays and a telephone connection is established between the mobile telephones, also in this case hiding telephone numbers according to what has previously been requested by the respected person. The persons can now talk to each other while further approaching each other. Several of the functions described above such as entering personal profiles, transmitting them to a server, obtaining a sorted list including indication of numbers, selecting a person on the list and obtaining a connection with this person can be accomplished using a conventional telephone set provided with a display and circuits for handling text messages.

1. A telephony network comprising mobile telephones communicating through the telephony network with a server, the mobile telephones comprising means for entering personal information, both for a person searching for contact and the profile for a searched person, and means for transmitting the personal information to the server, and the server comprising means for receiving personal information and storing it in a data base, characterized in that the telephone network comprises means for localizing/position determination of mobile telephones connected to the telephone network, and that the server comprises means for determining the geographical distance between two telephones connected to the network and to transmit to two mobile telephones in the case where they have been determined to be located at a distance from each other smaller than a threshold value, a signal thereof.

2. A telephone network according to claim 1, characterized in that the server is arranged to transmit, as the signal, ring signals to the mobile telephones, so that a connection can be established between the mobile telephones over the telephone network.

3. A telephone network according to claim 2, characterized in that the mobile telephones also comprise means for entering further information, this further information comprising whether a person searching for contact does not want presentation of her/his telephone number, and that he server is arranged that in establishing a connection between two mobile telephones not to make a presentation of telephone number/s in the case where information thereof has previously arrived from any of the two mobile telephones.

4. A telephone network according to claim 1, characterized in that the server comprises means for determining, by comparing received information on desired person to information previously stored in the database for persons searching for contact, persons, for whom their personal information totally or partly agrees with the personal information for desired person.

5. A telephone network according to claim 4, characterized in
that the server comprises means for transmitting a list of the determined persons to the mobile telephones, and
that the mobile telephones comprise means for displaying a transmitted list on a display unit.

6. A telephone network according to claim 5, characterized in that the mobile telephones comprise means for allowing a selection of a person on a transmitted list and means for transmitting information on selected person to the server.

7. A telephone network according to claim 6, characterized in that the server comprises means for establishing, when receiving information of selected person, a telephone connection between the mobile telephone of the person searching for contact and the mobile telephone of the selected person.

8. A telephone network according to claim 7, characterized in that the server is arranged not to show, for a special command from the mobile telephone, the telephone numbers of the mobile telephones to each other.

9. A telephone network according to claim 8, characterized in that the special command is included in the information entered in the mobile telephone by the person searching for contact.
